(19) United States
(12) Patent Application Publication
(10) Pub. No.: US 2026/0072989 A1
(43) Pub. Date: Mar. 12, 2026

(54) METHOD, APPARATUS AND ELECTRONIC DEVICE FOR DATA QUERY

(71) Applicant: Beijing Zitiao Network Technology Co., Ltd., Beijing (CN)

(72) Inventors: Bo Li, Beijing (CN); Ziqing Zhou, Beijing (CN)

(21) Appl. No.: 19/103,799

(22) PCT Filed: Mar. 20, 2024
(86) PCT No.: PCT/CN2024/082718

§ 371 Date: Feb. 13, 2025

(30) Foreign Application Priority Data
Mar. 22, 2023 (CN) 202310284664.4

(51) Int. Cl. G06F 16/9032; H04L 51/046

(52) U.S. Cl. CPC G06F 16/90332; H04L 51/046

(57) ABSTRACT

This disclosure provides a method, an apparatus and an electronic device for data query. One specific embodiment of the method includes: receiving a data query request triggered by a user through a conversation interface of a target conversation; obtaining feedback information corresponding to the data query request; and, based on the feedback information, outputting a response message in the target conversation, wherein the response message includes an interactive control for the user to adjust a query scope through the interactive control. According to this implementation, a function for data query is provided within the conversation, thereby enhancing the flexibility of data queries, allowing the query scope to be adjusted based on needs of the user, improving data query efficiency, and enhancing the user experience.

This application claims priority to the Chinese invention patent application No. 202310284664.4, titled “METHOD, APPARATUS AND ELECTRONIC DEVICE FOR DATA QUERY” filed on Mar. 22, 2023. The entire content of this application is incorporated herein by reference.

### FIELD

The present disclosure relates to the field of computer technology, and in particular, to a method, an apparatus and an electronic device for data query.

### BACKGROUND

With the continuous development of terminal technologies and network technologies, instant messaging tools are increasingly applied to daily lives and work of people. People can communicate with friends or group members within an instant messaging conversation. At present, if members in a conversation need to query and share data, they usually share the to-be-queried data table in the conversation, and users can open the data table for data queries. However, if the number and content of the data tables to be shared are too large, it can cause inconvenience in data querying. Therefore, there is a need for a more efficient and convenient data querying method.

### SUMMARY

The present disclosure provides a method, an apparatus and an electronic device for data query.

According to a first aspect, a method for data query is provided. The method includes:
receiving a data query request triggered by a user through a conversation interface of a target conversation;
obtaining feedback information corresponding to the data query request;
outputting, based on the feedback information, a response message in the target conversation, wherein the response message comprises an interactive control for the user to adjust a query scope through the interactive control.

According to a second aspect, an apparatus for data query is provided. The apparatus includes:
a receiving module configured to receive a data query request triggered by a user through a conversation interface of a target conversation;
an obtaining module configured to obtain feedback information corresponding to the data query request;
an outputting module configured to output, based on the feedback information, a response message in the target conversation, wherein the response message comprises an interactive control for the user to adjust a query scope through the interactive control.

According to a third aspect, a computer-readable storage medium is provided. The storage medium stores a computer program that, when executed by a processor, implements the method according to any of the methods in the first aspect.

According to a fourth aspect, an electronic device is provided. The electronic device includes a memory, a processor, and a computer program stored in the memory and executable by the processor. When the processor executes the program, it implements the method according to any of the methods in the first aspect.

The technical solutions provided in the embodiments of the present disclosure may have the following beneficial effects:
the method and the apparatus for data query provided in the embodiments of the present disclosure enable the obtaining of feedback information corresponding to a data query request triggered by the user in a target conversation. Based on this feedback information, a response message containing interactive controls is output in the target conversation for the user to adjust the query scope through the interactive controls. This approach facilitates data querying within the conversation, enhances the flexibility of data querying, allows the query scope to be adjusted according to user needs, improves the efficiency of data queries, and enhances user experience.

It should be understood that the above general description and the detailed description that follows are merely example and explanatory and are not intended to limit the present disclosure.

### BRIEF DESCRIPTION OF THE DRAWINGS

In order to more clearly illustrate the technical solutions of the embodiments in this specification, the drawings used in the descriptions of the embodiments are briefly introduced below. It is apparent that the following drawings only illustrate some of the embodiments described in this specification. For those skilled in the art, other drawings can also be obtained based on these drawings without requiring creative effort.

FIG. 1 is a schematic diagram of an example system architecture for applying an embodiment of the present disclosure;

FIG. 2 is a flowchart illustrating an information query method according to an example embodiment of the present disclosure;

FIG. 3 is a flowchart illustrating another information query method according to an example embodiment of the present disclosure;

FIG. 4A is an interface schematic diagram illustrating an information query solution according to an example embodiment of the present disclosure;

FIG. 4B is an interface schematic diagram illustrating another information query solution according to an example embodiment of the present disclosure;

FIG. 4C is an interface schematic diagram illustrating another information query solution according to an example embodiment of the present disclosure;

FIG. 4D is an interface schematic diagram illustrating another information query solution according to an example embodiment of the present disclosure;

FIG. 5 is a block diagram of an information query apparatus according to an example embodiment of the present disclosure;

FIG. 6 is a schematic block diagram of an electronic device provided by some embodiments of the present disclosure;

FIG. 7 is a schematic block diagram of another electronic device provided by some embodiments of the present disclosure;

FIG. 8 is a schematic diagram of a storage medium provided by some embodiment of the present disclosure.

### DETAILED DESCRIPTION

To enable those skilled in the art to better understand the technical solutions in this specification, the technical solutions in the embodiments of this specification are described clearly and comprehensively below in conjunction with the accompanying drawings of the embodiments. It is evident that the described embodiments are only part of the embodiments of this specification, not all embodiments. Based on the embodiments in this specification, all other embodiments obtained by a person skilled in the art without creative effort shall fall within the scope of protection of this specification.

When referring to the accompanying drawings in the following description, unless otherwise indicated, the same numbers in different drawings refer to the same or similar elements. The embodiments described in the following example embodiments do not represent all possible embodiments consistent with this disclosure. On the contrary, they are merely examples of apparatuses and methods consistent with some aspects of this disclosure, as detailed in the appended claims.

The terminology used in this disclosure is for the purpose of describing particular embodiments only and is not intended to limit the scope of the disclosure. In this disclosure, the singular forms “a,” “an,” “the,” and “that” are intended to include the plural forms unless the context clearly indicates otherwise. It should also be understood that the term “and/or” as used herein refers to and includes any and all possible combinations of one or more of the associated listed items.

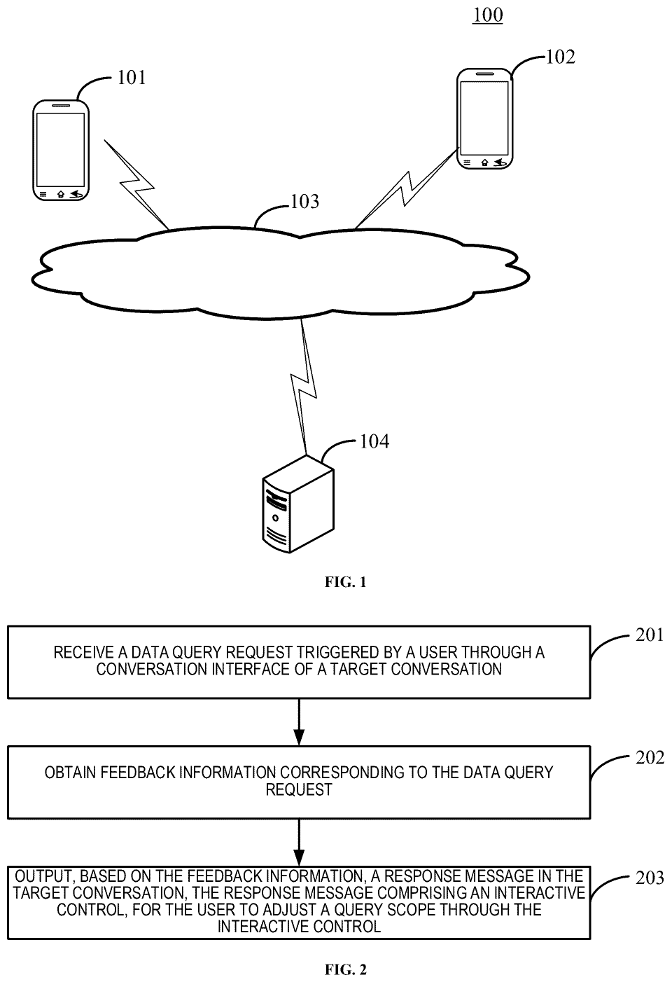

It should be understood that while terms such as “first,” “second,” and “third” may be used to describe various pieces of information in this disclosure, these pieces of information are not limited by these terms. These terms are used solely to distinguish pieces of information of the same type. For example, within the scope of this disclosure, the first information may also be referred to as the second information, and similarly, the second information may also be referred to as the first information. Depending on the context, the term “if,” as used herein, may be interpreted as “when” or “upon” or “in response to determining.” Refer to FIG. 1, which is a schematic diagram of an example system architecture to which the embodiments of the present disclosure are applicable.

As shown in FIG. 1, the system architecture 100 may include terminal devices 101 and 102, a network 103, and a server 104. It should be understood that the number or type of terminal devices, networks, and servers shown in FIG. 1 is merely illustrative. Depending on implementation needs, any number or type of terminal devices, networks, and servers may be present.

The network 103 serves as a communication link medium between terminal devices and servers. The network 103 may include various types of connections, such as wired, wireless communication links, optical fiber cables, and so on.

The terminal devices 101 and 102 can interact with the server through the network 103 to send or receive requests, information, and the like. The terminal devices 101 and 102 can be various electronic devices, including but not limited to smartphones, tablets, smart wearable devices, and personal digital assistants (PDAs).

The server 104 can store, analyze, and process the received data, and can also send control commands or requests to terminal devices or other servers. The server can provide services in response to user service requests. It should be understood that a server can provide one or more services, and the same service can also be provided by a plurality of servers.

Based on the system architecture shown in FIG. 1, in the embodiments of the present disclosure, when a user triggers a data query request in a conversation interface on terminal device 101 or terminal device 102, the terminal device can send the data query request to server 104 through network 103. After receiving the data query request, the server 104 can obtain feedback information corresponding to the data query request and return the feedback information to terminal device 101 or terminal device 102. The terminal device 101 or terminal device 102 then outputs a response message in the target conversation, including interactive controls, based on the feedback information. This allows the user to adjust the query scope using the interactive controls.

The following provides a detailed description of the present disclosure in conjunction with specific embodiments.

FIG. 2 is a flowchart illustrating an information query method according to an example embodiment. The execution entity of this method can be implemented as any terminal device, platform, server, or device cluster with computing and processing capabilities. The method includes the following steps:
as shown in FIG. 2, in Step 201, receive a data query request triggered by a user through a conversation interface of a target conversation.

In this embodiment, the target conversation can be a window for message transmission between users in an instant messaging client. The target conversation may be a one-to-one chat conversation between two users or a group chat conversation among a plurality of users. After logging into the instant messaging client, the user can send messages to friends or group members within the target conversation. The user triggering the data query request is a conversation member of the target conversation. This user may be the administrator of the target conversation, a member designated by the administrator, or any ordinary member of the target conversation. It should be understood that this embodiment does not impose restrictions on the specific identity of the target user.

In one implementation, the data query request triggered by the user in the conversation interface of the target conversation can be a conversation message containing preset characters sent by the user within the target conversation. The conversation message may also include keywords or other information for the query. For example, the preset characters may include characters used to mention a chatbot, and the conversation message may append keywords for the query following the chatbot-mentioning characters.

In another implementation, the data query request triggered by the user in the conversation interface of the target conversation can also be a data query request entered in a page associated with a preset control triggered within the target conversation. For example, the preset control may be a control for querying data within the conversation. The user can trigger this preset control within the target conversation, causing the instant messaging client to output the page associated with the preset control. The user can enter a data query request including keywords in the page associated with the preset control.

In Step 202, obtain feedback information corresponding to the data query request.

In some embodiments, the data query can be managed by the instant messaging server corresponding to the instant messaging client or by other servers interfacing with the instant messaging server. The server managing the data query can access a specified database, which stores at least one information set (e.g., the information set may be an online data table). Each information set corresponds to a corresponding object (e.g., each online data table may correspond to a chatbot or a preset control). The target information set is the information set bound to the corresponding object of the target conversation (e.g., a chatbot added to the target conversation or a preset control added to the target conversation). The target information set includes a first information set (e.g., the first information set may be at least part of a subset of an online data table, or part of the rows or columns in the subset of a first online data table). The first information set has an association with the target conversation.

In Step 203, based on the feedback information, output a response message in the target conversation, wherein the response message comprises an interactive control for the user to adjust a query scope through the interactive control.

In this embodiment, the feedback information can be obtained based on the data query request. The feedback information may include query results or the data source containing the data to be queried. A response message can be output in the target conversation based on the feedback information. The response message may include interactive controls, and the user can adjust the query scope using these controls. After the user adjusts the query scope via the interactive controls, the target query results based on the adjusted scope can be obtained and displayed to the user.

The data query method provided by the present disclosure enables obtaining feedback information corresponding to a data query request triggered by the user in the target conversation. Based on this feedback information, a response message containing interactive controls is output in the target conversation, allowing the user to adjust the query scope through these controls. This method provides data querying functionality within the conversation, enhances the flexibility of data queries, enables users to adjust the query scope as needed, improves the efficiency of data querying, and enhances the user experience.

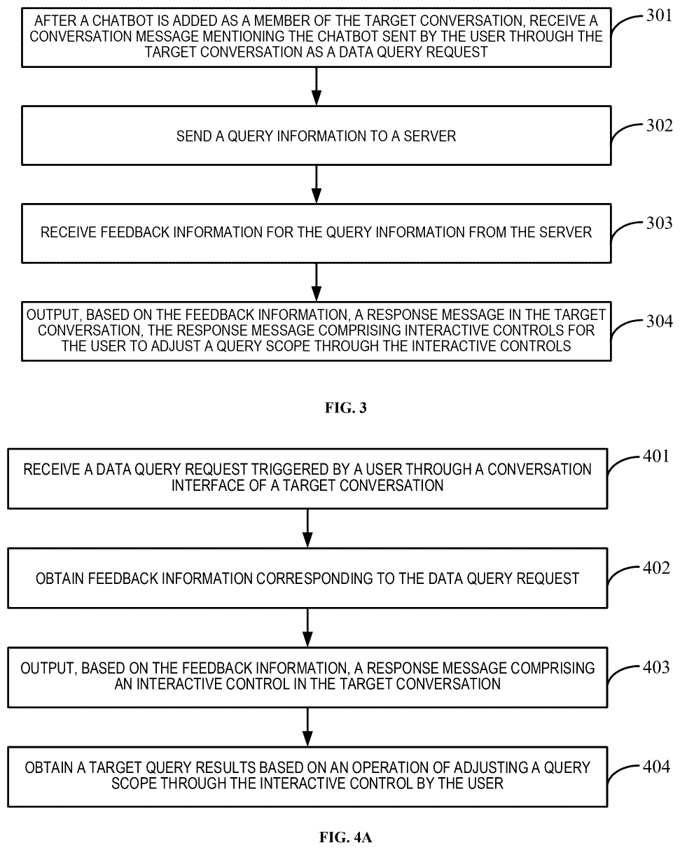

FIG. 3 is a flowchart illustrating another information query method according to an example embodiment. This embodiment describes the process of obtaining feedback information. The execution entity of this method can be implemented as any terminal device, platform, server, or device cluster with computing and processing capabilities. The method includes the following steps:

As shown in FIG. 3, in Step 301, after a chatbot is added as a member of the target conversation, receive a conversation message mentioning the chatbot sent by the user through the target conversation as a data query request.

In this embodiment, the data query request can be triggered by the user in the conversation interface of the target conversation after the chatbot has been added as a member. Specifically, the data query request can be a conversation message mentioning the chatbot, which also includes keywords or other information for the query. For example, the conversation message may append keywords or other information for the query following the characters used to mention the chatbot.

In Step 302, send, to a server, a query information, and in Step 303, receive feedback information for the query information from the server.

In this embodiment, the data query can be managed by the server. The server stores at least one information set (e.g., an online data table), and each information set can be bound to a chatbot. The chatbot added to the target conversation is bound to a target information set, which includes a first information set associated with the target conversation.

In this embodiment, the instant messaging client can send query information to the server. The query information may include keywords for querying data, as well as the identifier of the chatbot and/or the identifier of the target conversation.

In one implementation, the server can identify the target information set bound to the chatbot by using the chatbot identifier included in the query information. The server retrieves the feedback information based on the target information set and returns the feedback information to the instant messaging client.

In another implementation, the server can identify the information set associated with the target conversation by using the target conversation identifier included in the query information. The server retrieves the feedback information based on the identified information set and returns the feedback information to the instant messaging client.

In yet another implementation, the server can identify the target information set bound to the chatbot by using the chatbot identifier included in the query information. The server then identifies the first information set associated with the target conversation identifier within the target information set. The feedback information is retrieved based on the first information set and returned to the instant messaging client.

In Step 304, based on the feedback information, output a response message in the target conversation, the response message comprises interactive controls for the user to adjust a query scope through the interactive controls.

In this embodiment, the feedback information can be obtained from a data set associated with the chatbot and/or the target conversation. The feedback information may include query results or the data source containing the data to be queried. Based on the feedback information, a response message containing interactive controls can be sent in the target conversation through the chatbot as a conversation message. This allows the user to adjust the query scope using the interactive controls.

Since this embodiment enables data queries through the chatbot after it has been added as a member of the target conversation, it further enhances the flexibility of data queries, improves query efficiency, and enhances the user experience.

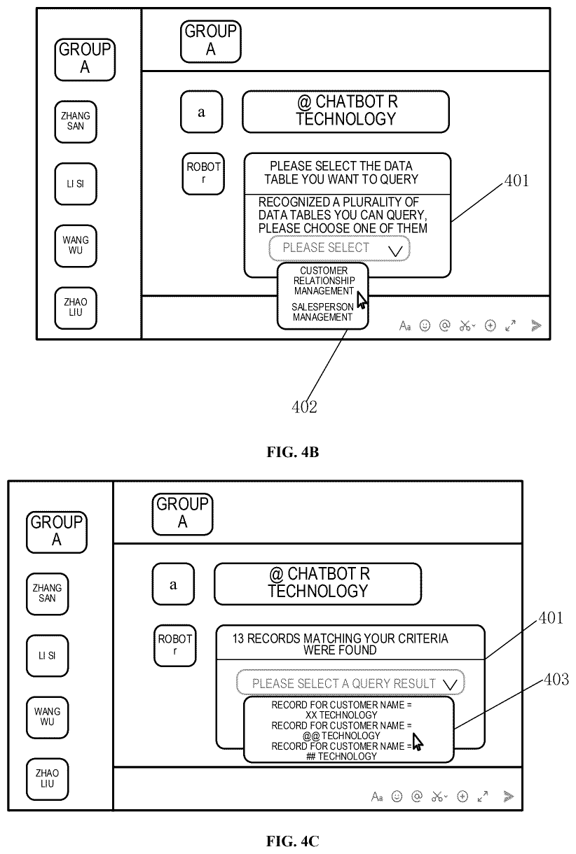

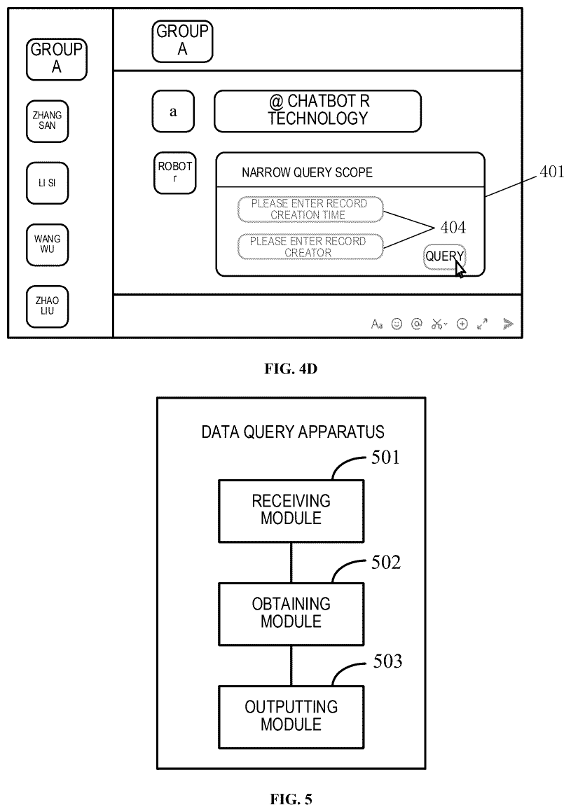

FIG. 4A is a flowchart illustrating another data query method according to an example embodiment. This embodiment describes the process of outputting a response message. The execution entity of this method can be implemented as any terminal device, platform, server, or device cluster with computing and processing capabilities. The method includes the following steps:

As shown in FIG. 4A, in Step 401, receive a data query request triggered by a user through a conversation interface of a target conversation. In Step 402, obtain feedback information corresponding to the data query request.

In this embodiment, based on the data query request triggered by the user through the conversation interface of the target conversation, keywords for the query can be obtained, and the query scope can be determined. The feedback information is then obtained according to the query scope and the keywords.

In Step 403, based on the feedback information, output a response message comprising an interactive control in the target conversation. In Step 404, obtain a target query results based on an operation of adjusting a query scope through the interactive control by the user.

In one case, if the feedback information includes a plurality of data sources, the interactive controls output in the target conversation may include a plurality of data source options. The plurality of data sources may represent different information sets, such as a plurality of different online data tables or a plurality of different subsets within a single online data table. It should be understood that this embodiment does not limit the specific forms of data sources. Specifically, a plurality of data source options can be provided within the interactive controls output in the target conversation. The user can select the target data source, for example, by using a dropdown menu or checkbox. After the user selects the target data source, the target query results can be obtained from the selected data source based on the keywords included in the data query request. These target query results are then output in the target conversation.

As shown in FIG. 4B, user a can send a data query request in a conversation of group A. The data query request is the message “@Chatbot r Technology” where the chatbot r has already been added as a member of group A. The word “Technology” in the message serves as the query keyword. After the instant messaging client receives the feedback information for this data query request, the interactive control 401 can be output in the form of a message sent by chatbot r in group A. If the feedback information includes a plurality of data sources, these data sources can be displayed in the dropdown menu 402 within interactive control 401 for user selection. For example, as shown in FIG. 4B, the plurality of data sources are a data table named “Customer Relationship Management” and a data table named “Salesperson Management.”

In another case, if the feedback information includes a plurality of query results (e.g., the number of query results is less than or equal to a preset number), the interactive controls output in the target conversation may include a plurality of options corresponding to these query results. The user can select a target query result from these options to view detailed information. Each query result corresponds to an option. The content displayed in the interactive controls for each option can include partial information from the query result. For example, if the query result is obtained from a data record, the content displayed in the interactive control for the corresponding option may include field values from certain fields in the data record, such as fields representing names, categories, or regions. The user can select a target query result through the interactive controls, and the details of the selected target query result can be displayed within the interactive controls.

As shown in FIG. 4C, using the example where user a sends a data query request in a conversation of group A with the message “@Chatbot r Technology” after the instant messaging client receives the feedback information for this data query request, the interactive control 401 is output in group A in the form of a message sent by chatbot r. If the feedback information includes a plurality of query results, the dropdown menu 403 within interactive control 401 can list partial contents of these query results (for example, field values of the customer name field), allowing the user to select the desired result.

In another case, if the feedback information includes a plurality of query results and the number of these results exceeds a predetermined limit (e.g., 8), the interactive control output in the target conversation can include one or more filtering condition setting controls. The user can use these filtering condition setting controls to further filter the query results from the feedback information. For example, if the query results are obtained from data records, the filtering conditions associated with the filtering condition setting controls can include, but are not limited to, the creator of the data record, the creation time of the data record, or one or more fields within the data record (such as fields representing the name, category, or region). The user can set filtering conditions for the data using the filtering condition setting controls in the interactive control. Based on the filtering conditions set by the user, the query results can be further filtered to obtain the target query results. The detailed information of the target query results can then be displayed within the interactive control.

As shown in FIG. 4D, taking the data query request in which user a sends the content “@, Chatbot r Technology” in a conversation of group A as an example, after the instant messaging client receives feedback information regarding this data query request, an interactive control 401 is output in group A's conversation in the form of a message sent by chatbot r. If the feedback information includes a plurality of query results, the interactive control 401 can include a filtering condition setting control 404. Users can set filtering conditions for the query data through the filtering condition setting control 404 to narrow the query scope based on these filtering conditions. As shown in FIG. 4D, the filtering condition setting control 404 can be used to set filtering conditions such as the data record creation time and the creator of the data record.

In this embodiment, users can narrow the query scope through the interactive control, allowing them to filter the query results based on their preferences and needs. This avoids searching for data within a query range that does not interest users, thus improving data query efficiency and enhancing user experience.

It should be noted that although the operations of the method embodiments described above are presented in a specific sequence, this does not require or imply that these operations must be executed in that specific order, nor is it necessary to execute all the operations shown to achieve the desired results. On the contrary, the steps illustrated in the flowcharts can be executed in a different order. Additionally or alternatively, some steps may be omitted, a plurality of steps may be combined into a single step, and/or a single step may be split into a plurality of steps.

Corresponding to the aforementioned data query method embodiment, the present disclosure also provides an embodiment of a data query apparatus.

As shown in FIG. 5, FIG. 5 is a block diagram of a data query apparatus according to an example embodiment of the present disclosure. The apparatus can include: a receiving module 501, an obtaining module 502, and an outputting module 503.

The receiving module 501 is configured to receive a data query request triggered by a user through a conversation interface of a target conversation.

The obtaining module 502 is configured to obtain feedback information corresponding to the data query request.

The output module 503 is configured to output, based on the feedback information, a response message in the target conversation, wherein the response message comprises an interactive control for the user to adjust a query scope through the interactive control.

In some embodiments, the interactive control may include a plurality of data source options.

Additionally, the apparatus may also include a display module (not shown in the figure). The display module is configured to in response to a data source selection operation of the user based on the plurality of data source options, output a query result in the target conversation, wherein the query result is obtained, based on the data query request, from a data source selected by the user.

In other embodiments, if the feedback information comprises a plurality of query results, the interactive control comprises a plurality of options corresponding to the plurality of query results for the user to select, from the plurality of options, a target query result for displaying details.

In other embodiments, if the feedback information comprises a plurality of query results, the interactive control comprises one or more filtering condition setting controls, the filtering condition setting control is configured to further filter a query result from the feedback information.

In other embodiments, a filtering condition corresponding to the one or more filtering condition setting controls comprises one or more of the following: a creator of a data record; a creation time of a data record; or values of one or more fields in a data record.

In other embodiments, the data query request may include: a conversation message that comprises a predetermined character and is sent by the user in the target conversation, or a data query request that is entered to a page associated with a predetermined control after the user triggers the predetermined control in the target conversation.

In other embodiments, f the data query request comprises the conversation message that comprises the predetermined character and is sent by the user in the target conversation, the data query request is triggered after a chatbot is added as a member of the target conversation, the conversation message is a conversation message that mentions the chatbot and comprises a keyword for a query.

In other embodiments, the obtaining module 502 is configured to send, to a server, a query information comprising the keyword and an identifier of the chatbot and/or an identifier of the target conversation. The server receives feedback information for the query information from the server, the feedback information is obtained from a data set associated with the chatbot and/or the target conversation.

For the apparatus embodiment, as it generally corresponds to the method embodiment, refer to the explanation of the method embodiment for relevant details. The apparatus embodiments described above are merely illustrative. The units described as separate components may or may not be physically separated. Components displayed as units may or may not be physical units, i.e., they can be located in one place or distributed across a plurality of network units. Some or all of the modules can be selected based on actual needs to achieve the objectives of the present disclosure. Those skilled in the art can understand and implement the invention without creative effort.

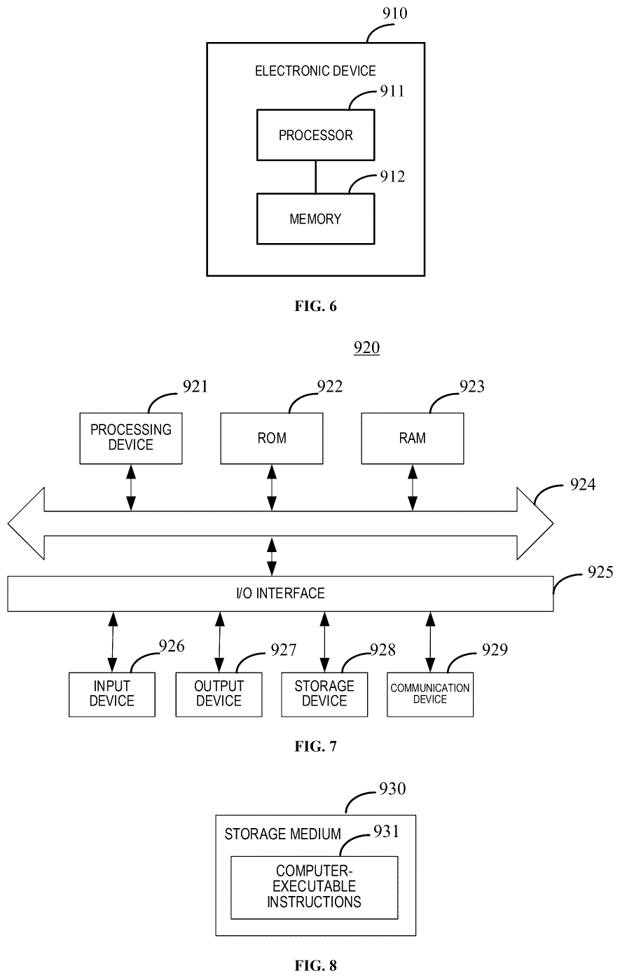

FIG. 6 is a schematic block diagram of an electronic device provided by some embodiments of the present disclosure. As shown in FIG. 6, the electronic device 910 includes a processor 911 and a memory 912, which can be used to implement a client or server. The memory 912 is used for the non-transitory storage of computer-executable instructions (e.g., one or more computer program modules). The processor 911 is used to execute the computer-executable instructions. When executed by the processor 911, these instructions can perform one or more steps in the data query method described above, thereby implementing the data query method. The memory 912 and processor 911 can be interconnected through a bus system and/or other types of connection mechanisms (not shown).

For example, the processor 911 can be a Central Processing Unit (CPU), a Graphics Processing Unit (GPU), or another type of processing unit with data processing and/or program execution capabilities. For example, the CPU can be based on architectures such as X86 or ARM. The processor 911 can be a general-purpose processor or a specialized processor and can control other components in the electronic device 910 to perform desired functions.

For example, the memory 912 can include any combination of one or more computer program products, which may comprise various types of computer-readable storage media, such as volatile and/or non-volatile memory. Volatile memory may include Random Access Memory (RAM) and/or cache memory, among others. Non-volatile memory may include Read-Only Memory (ROM), hard drives, Erasable Programmable Read-Only Memory (EPROM), Compact Disk Read-Only Memory (CD-ROM), USB storage devices, flash memory, etc. One or more computer program modules can be stored on the computer-readable storage medium, and the processor 911 can execute these modules to realize various functions of the electronic device 910. Various applications and data, as well as data used and/or generated by applications, can also be stored in the computer-readable storage medium.

It should be noted that, in the embodiments of the present disclosure, the specific functions and technical effects of the electronic device 910 can refer to the description of the data query method above, and therefore, they are not reiterated here.

FIG. 7 is a schematic block diagram of another electronic device provided by some embodiments of the present disclosure. The electronic device 920 is, for example, suitable for implementing the data query method provided by the embodiments of this disclosure. The electronic device 920 can be a terminal device and can function as a client or a server. The electronic device 920 may include, but is not limited to, mobile terminals such as mobile phones, laptops, digital broadcast receivers, PDAs (Personal Digital Assistants), PADs (tablets), PMPs (Portable Multimedia Players), in-car terminals (e.g., in-vehicle navigation terminals), wearable electronic devices, and fixed terminals such as digital TVs, desktop computers, smart home devices, etc. It should be noted that the electronic device 920 shown in FIG. 7 is merely an example and does not limit the functionality or scope of the embodiments of the present disclosure.

As shown in FIG. 7, the electronic device 920 can include a processing device (e.g., a central processor, graphics processor, etc.) 921, which can execute various appropriate actions and processes based on programs stored in the Read-Only Memory (ROM) 922 or programs loaded from the storage device 928 into the Random Access Memory (RAM) 923. Various programs and data required for the operation of the electronic device 920 are also stored in RAM 923. The processing device 921, ROM 922, and RAM 923 are interconnected via a bus 924. An Input/Output (I/O) interface 925 is also connected to the bus 924.

Typically, the following devices can be connected to the I/O interface 925: input devices 926 such as touch screens, touchpads, keyboards, mice, cameras, microphones, accelerometers, gyroscopes, etc. ; output devices 927 such as Liquid Crystal Displays (LCDs), speakers, and vibrators; storage devices 928 such as magnetic tapes, hard drives, etc.; and communication devices 929. The communication device 929 allows the electronic device 920 to perform wired or wireless communication with other electronic devices for data exchange. Although FIG. 7 shows an electronic device 920 with various components, it should be understood that it is not necessary to implement or include all the devices shown. The electronic device 920 may alternatively implement or include more or fewer devices.

For example, in the embodiments of the present disclosure, the aforementioned data query method can be implemented as a computer software program. For instance, an embodiment of the present disclosure includes a computer program product that contains a computer program stored on a non-transitory computer-readable medium. This computer program includes program code for executing the steps of the aforementioned data query method. In such an embodiment, the computer program can be downloaded and installed via the communication device 929 from a network, installed from the storage device 928, or installed from the ROM 922. When the computer program is executed by the processing device 921, the functions defined in the data query method provided by the embodiments of the present disclosure can be realized.

FIG. 8 is a schematic diagram of a storage medium provided by some embodiments of the present disclosure. As shown in FIG. 8, the storage medium 930 can be a non-transitory computer-readable storage medium used to store non-transitory computer-executable instructions 931. When the non-transitory computer-executable instructions 931 are executed by a processor, they can implement the data query method described in the embodiments of the present disclosure. For example, when the non-transitory computer-executable instructions 931 are executed by a processor, one or more steps of the aforementioned data query method may be performed.

The storage medium 930 can be applied to the aforementioned electronic devices. For example, the storage medium 930 can be part of the memory within an electronic device.

The storage medium can include a smartphone's memory card, a tablet's storage component, a personal computer's hard drive, Random Access Memory (RAM). Read-Only Memory (ROM), Erasable Programmable Read-Only Memory (EPROM). Compact Disk Read-Only Memory (CD-ROM), flash memory, or any combination of the aforementioned storage media. Other applicable storage media may also be used.

The description of the storage medium 930 can refer to the description of the memory provided in the electronic device embodiments; repetitive details will not be reiterated. The specific functions and technical effects of the storage medium 930 can refer to the data query method described above, and will not be repeated here.

It should be noted that in the context of the present disclosure, a computer-readable medium refers to a tangible medium that can contain or store programs for use by, or in connection with, an instruction execution system, an apparatus, or a device. A computer-readable medium can be a computer-readable signal medium, a computer-readable storage medium, or any combination of the two. A computer-readable storage medium can include, but is not limited to, electrical, magnetic, optical, electromagnetic, infrared, or semiconductor systems, devices, or apparatuses, or any combination thereof. More specific examples of computer-readable storage media include, but are not limited to: electrical connections with one or more wires, portable computer disks, hard disks, RAM, ROM, EPROM (or flash memory), optical fibers, portable compact disk read-only memory (CD-ROM), optical storage devices, magnetic storage devices, or any suitable combination of the above. In the present disclosure, a computer-readable storage medium may be any tangible medium containing or storing a program that may be used by or in combination with an instruction execution system, an apparatus or means. In the context of this disclosure, a computer-readable storage medium may include propagated data signals that carry computer-readable program code, such as in baseband or as part of a carrier wave. These propagated data signals can take various forms, including, but not limited to, electromagnetic signals, optical signals, or any suitable combination of these. A computer-readable signal medium is any computer-readable medium other than a computer-readable storage medium that can transmit, propagate, or deliver a program for use by, or in connection with, an instruction execution system, an apparatus, or a device. The program code contained on a computer-readable medium can be transmitted using any appropriate medium, including, but not limited to, electrical wiring, fiber optic cables, radio frequency (RF), or any suitable combination of the above.

Those skilled in the art, after considering the specification and practicing the invention disclosed herein, will readily come up with other embodiments of the present disclosure. The present disclosure aims to cover any modifications, applications, or adaptive changes that follow the general principles of this disclosure and include known common knowledge or conventional technical means in the field that are not explicitly disclosed. The specification and examples should be considered illustrative, and the true scope and spirit of the disclosure are defined by the appended claims.

It should be understood that the present disclosure is not limited to the precise structures described above and shown in the accompanying drawings, and various modifications and changes can be made without departing from its scope. The scope of the present disclosure is limited solely by the appended claims.

1. A method for data query, comprising:
receiving a data query request triggered by a user through a conversation interface of a target conversation;
obtaining feedback information corresponding to the data query request;
outputting, based on the feedback information, a response message in the target conversation, wherein the response message comprises an interactive control for the user to adjust a query scope through the interactive control.

2. The method of claim 1, wherein
the interactive control comprises a plurality of data source options;
wherein the method further comprises: in response to a data source selection operation of the user based on the plurality of data source options, outputting a query result in the target conversation, wherein the query result is obtained, based on the data query request, from a data source selected by the user.

3. The method of claim 1, wherein
in accordance with a determination that the feedback information comprises a plurality of query results, the interactive control comprises a plurality of options corresponding to the plurality of query results for the user to select, from the plurality of options, a target query result for displaying details.

4. The method of claim 1, wherein
in accordance with a determination that the feedback information comprises a plurality of query results, the interactive control comprises one or more filtering condition setting controls; the filtering condition setting control is configured to further filter a query result from the feedback information.

5. The method of claim 4, wherein a filtering condition corresponding to the one or more filtering condition setting controls comprises one or more of the following:
a creator of a data record;
a creation time of a data record;
values of one or more fields in a data record.

6. The method of claim 1, wherein the data query request comprises:
a conversation message that comprises a predetermined character and is sent by the user in the target conversation; or
a data query request that is entered to a page associated with a predetermined control after the user triggers the predetermined control in the target conversation.

7. The method of claim 6, wherein in accordance with a determination that the data query request comprises the conversation message that comprises the predetermined character and is sent by the user in the target conversation,
the data query request is triggered after a chatbot is added as a member of the target conversation, the conversation message is a conversation message that mentions the chatbot and comprises a keyword for a query.

8. The method of claim 7, wherein obtaining the feedback information corresponding to the data query request comprises:
sending, to a server, a query information comprising the keyword and an identifier of the chatbot and/or an identifier of the target conversation;
receiving feedback information for the query information from the server, the feedback information is obtained from a data set associated with the chatbot and/or the target conversation.

9. (canceled)

10. (canceled)

11. An electronic device comprising a memory and a processor, the memory having executable code stored therein, and when executing the executable code, the processor performs acts comprising:
receiving a data query request triggered by a user through a conversation interface of a target conversation;
obtaining feedback information corresponding to the data query request;
outputting, based on the feedback information, a response message in the target conversation, wherein the response message comprises an interactive control for the user to adjust a query scope through the interactive control.

12. The electronic device of claim 11, wherein
the interactive control comprises a plurality of data source options;
wherein the acts further comprise: in response to a data source selection operation of the user based on the plurality of data source options, outputting a query result in the target conversation, wherein the query result is obtained, based on the data query request, from a data source selected by the user.

13. The electronic device of claim 11, wherein
in accordance with a determination that the feedback information comprises a plurality of query results, the interactive control comprises a plurality of options corresponding to the plurality of query results for the user to select, from the plurality of options, a target query result for displaying details.

14. The electronic device of claim 11, wherein
in accordance with a determination that the feedback information comprises a plurality of query results, the interactive control comprises one or more filtering condition setting controls; the filtering condition setting control is configured to further filter a query result from the feedback information.

15. The electronic device of claim 14, wherein a filtering condition corresponding to the one or more filtering condition setting controls comprises one or more of the following:
a creator of a data record;
a creation time of a data record;
values of one or more fields in a data record.

16. The electronic device of claim 11, wherein the data query request comprises:
an electronic message that comprises a predetermined character and is sent by the user in the target conversation; or
a data query request that is entered to a page associated with a predetermined control after the user triggers the predetermined control in the target conversation.

17. The electronic device of claim 16, wherein in accordance with a determination that the data query request comprises the electronic message that comprises the predetermined character and is sent by the user in the target conversation,
the data query request is triggered after a chatbot is added as a member of the target conversation, the electronic message is an electronic message that mentions the chatbot and comprises a keyword for a query.

18. The electronic device of claim 17, wherein obtaining the feedback information corresponding to the data query request comprises:
sending, to a server, a query information comprising the keyword and an identifier of the chatbot and/or an identifier of the target conversation;
receiving feedback information for the query information from the server, the feedback information is obtained from a data set associated with the chatbot and/or the target conversation.

19. A non-transitory computer-readable storage medium having a computer program stored thereon, wherein when being executed in a computer, the computer program causes the computer to perform acts comprising:
receiving a data query request triggered by a user through a conversation interface of a target conversation;
obtaining feedback information corresponding to the data query request;
outputting, based on the feedback information, a response message in the target conversation, wherein the response message comprises an interactive control for the user to adjust a query scope through the interactive control.

20. The non-transitory computer-readable storage medium of claim 19, wherein
the interactive control comprises a plurality of data source options;
wherein the acts further comprise: in response to a data source selection operation of the user based on the plurality of data source options, outputting a query result in the target conversation, wherein the query result is obtained, based on the data query request, from a data source selected by the user.

21. The non-transitory computer-readable storage medium of claim 19, wherein
in accordance with a determination that the feedback information comprises a plurality of query results, the interactive control comprises a plurality of options corresponding to the plurality of query results for the user to select, from the plurality of options, a target query result for displaying details.

22. The non-transitory computer-readable storage medium of claim 19, wherein
in accordance with a determination that the feedback information comprises a plurality of query results, the interactive control comprises one or more filtering condition setting controls; the filtering condition setting control is configured to further filter a query result from the feedback information.
